(19) United States
(12) Patent Application Publication
(10) Pub. No.: US 2016/0146992 A1
(43) Pub. Date: May 26, 2016

(54) METHOD AND APPARATUS FOR DECORATING A LENS OF AN ELECTRONIC DEVICE

(71) Applicant: Google Technology Holdings LLC, Mountain View, CA (US)

(72) Inventors: Daniel S. Thorstenson, Chicago, IL (US); Rachid Alameh, Crystal Lake, IL (US); John Delianides, Libertyville, IL (US); John J. Gorsica, Round Lake, IL (US)

(21) Appl. No.: 14/275,921

(22) Filed: May 13, 2014

Related U.S. Application Data
(60) Provisional application No. 61/972,538, filed on Mar. 31, 2014.

(51) Int. Cl. G02B 5/28; G02B 13/14

(52) U.S. Cl. CPC G02B 5/281; G02B 5/285; G02B 13/14

(57) ABSTRACT

A decorated lens has a transparent layer applied within a first area of the lens, wherein the transparent layer is transparent to light in a visible band and transparent to light in an infrared band. The decorated lens also includes a dichroic filter layer applied within the first area of the lens, wherein the dichroic filter layer is transparent to the light in the infrared band. The transparent layer and the dichroic filter layer in combination create a visibly opaque coating on the first area of the lens.

### FIELD OF THE DISCLOSURE

The present disclosure relates to a lens decoration and more particularly to a method and apparatus for a lens decoration that is visibly opaque and transparent to light in the infrared band.

### BACKGROUND

In the field of electronic devices, such as tablets, mobile phones, personal media players, and the like, device components and device aesthetics should interoperate effectively. Some devices include proximity elements that emit and sense impingements of infrared light also referred to herein as light in an infrared band. These elements are designed to detect objects that are near the electronic device. In performing their function, these elements sometimes emit infrared light that passes through a lens and decoration of the electronic device. The decoration should be aesthetically pleasing, but allow the device components to operate well.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of an electronic device that is configurable to implement embodiments of the present teachings.

FIG. 2 illustrates a transparent layer in combination with a dichroic filter layer providing a coating on a lens in accordance with the present teachings.

FIG. 3 illustrates a transparent layer in combination with a dichroic filter layer and an opaque layer providing a coating on a lens in accordance with the present teachings.

FIG. 4 is a logical flow diagram illustrating a general method of decorating a lens in accordance with the present teachings.

FIG. 5 is a logical flow diagram illustrating a more detailed method of decorating a lens in accordance with the present teachings.

FIG. 6 illustrates multiple views of an electronic device having a lens decorated in accordance an embodiment of the present teachings.

FIG. 7 illustrates multiple views of an electronic device having a lens decorated in accordance with another embodiment of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Generally speaking, pursuant to the various embodiments, the present disclosure provides for a decorated lens that includes a lens, a transparent layer applied within a first area of the lens, and a dichroic filter layer applied within the first area of the lens. The transparent layer is transparent to light in a visible band and transparent to light in an infrared band. The dichroic filter layer is transparent to the light in the infrared band. The transparent layer and the dichroic filter layer in combination create a visibly opaque coating on the first area of the lens.

Further in accordance with the teachings provided herein is a method of manufacturing a decorated lens. The method includes applying a transparent layer within a first area of a lens. The transparent layer is transparent to light in a visible band and transparent to light in an infrared band. The method also includes applying a visibly opaque dichroic filter layer within the first area of the lens. The dichroic filter layer is transparent to the light in the infrared band.

In another example, herein is provided an electronic device having a decorated lens in accordance with the present teachings. The electronic device includes at least one infrared element configured to communicate light in the infrared band and a lens having at least a portion of a border of the lens that covers the infrared element. The electronic device also includes a transparent layer applied adjacent to the lens in the first area, wherein the transparent layer is transparent to light in a visible band and transparent to light in an infrared band. The electronic device further includes a cold mirror directly applied to the transparent layer, wherein the transparent layer and the cold mirror in combination create a uniform visibly opaque coating on at least the portion of the border of the lens that covers the infrared element.

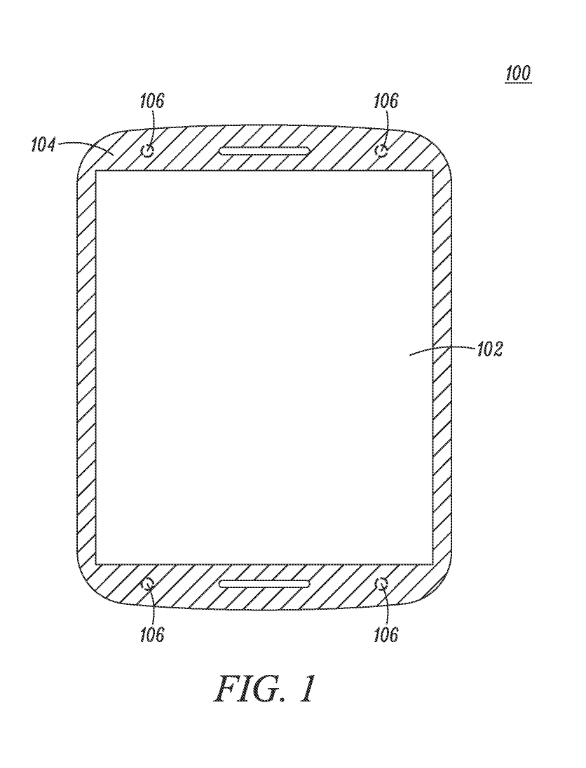

Referring now to the drawings, and in particular to FIG. 1, which illustrates a plan view of a portable electronic device, which is configurable to implement embodiments of the present teachings. Although the electronic device 100 depicted in FIG. 1 is a smartphone, embodiments disclosed herein are not limited to smartphones but may be implemented on any other type of electronic device having a lens. In some examples, instead of a smartphone, the electronic device 100 can be a cellular phone, a phablet, a tablet, a television, a computer monitor, a camera, a wearable device such as a smart watch or smart glasses, and the like.

As shown, the electronic device 100 has a lens having a total surface area that includes a first area 104 and a second area 102, which is outside of or exclusive of the first area 104. The first area 104 is also interchangeably referred to herein as a border of the lens, which means an area that forms at least a portion of an outer edge, boundary, or perimeter of the lens. The second area 102 serves as and is also referred to herein interchangeably as a viewing region. The viewing region 102, also known as a screen, is configured to display images thereon.

Conversely, the first area 104 is a non-viewing region, which does not display images, but may include ornamental or decorative features, referred to generally herein as a decoration. In some cases, the decoration also has a functional component such as the common practice in the art of applying black ink to the first area 104 to hide electrical components that are internally located beneath the first area 104. One example is to hide one or more infrared elements located, for instance, behind regions 106 of the border 104, as indicated by the dashed circles.

However, users of electronic devices typically desire decorative features that offer a variety of colors. As used herein, black means lacking or substantially hue and brightness and absorbing light in a visible band without reflecting any or substantially any of the rays composing the light. Conversely color, also referred to herein as non-black, is defined as a visual perceptual property characterized by the quality of an object or substance with respect to light in the visible band that is reflected by the object, usually determined by measurement of hue, saturation, and brightness of the reflected light.

One example benefit of the present teachings is the provision of a visually opaque coating over the border of a lens of an electronic device that can be configured to have different colors while still effectively hiding electronics, such as infrared elements, located behind the coating. Another example benefit is that the visually opaque coating can be configured to have different colors. Yet another example benefit is that a visually opaque coating in accordance with the present teachings can be configured as a uniform coating over the location of electronics, like infrared elements, which does not interfere with operation of those electronics. Within the context of the present teachings a coating in a particular area, at a minimum, has no openings is that particular area.

As used herein, opaque means more reflective, scattering, or absorptive than transmissive of light or electromagnetic radiation having certain wavelengths, where transmissive is characterizes by a percentage of light that can be passed through a substance, material, layer, or coating. Particularly, visually opaque means more reflective, scattering, or absorptive than transmissive of light in the visual band. Moreover, as used herein, transparent means more transmissive than reflective, scattering, or absorptive of light. In one example, an opaque substance, material, layer, or coating is less than 50% transmissive of light, and a transparent substance, material, layer, or coating is 50% or more transmissive of light. Thus, levels of opacity can range between zero to less than 50% opacity; and levels of transparency can range from 50% to 100% transmissive.

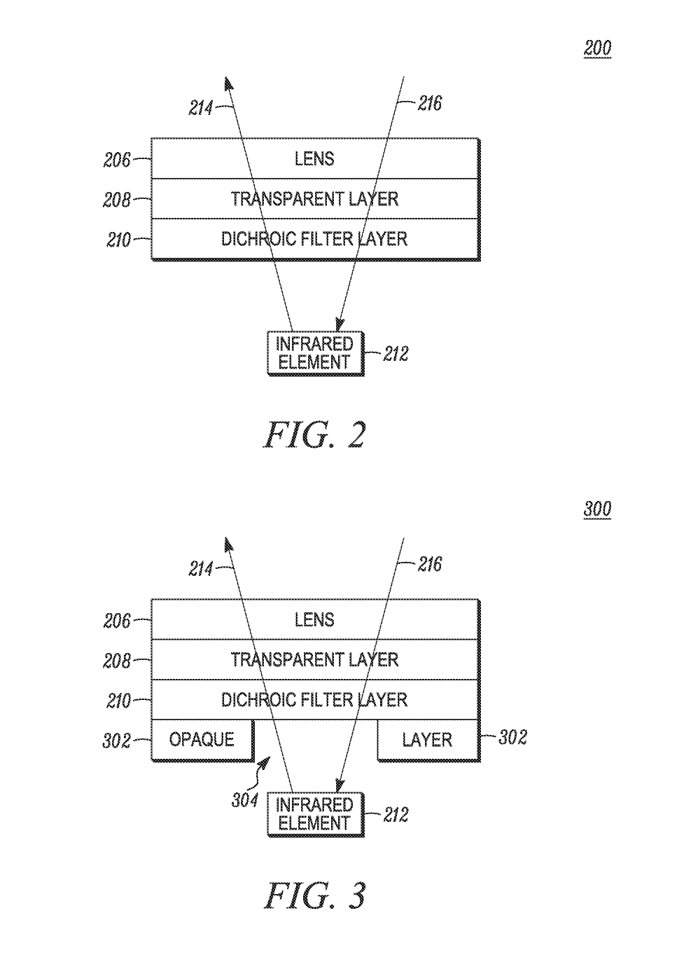

As mentioned above, at least one embodiment of the present teachings is directed to a lens that is decorated with a visibly opaque coating over at least a portion of the border. In a first embodiment illustrated by reference to apparatus 200 shown in FIG. 2, the visibly opaque layer includes two layers. In a second embodiment illustrated by reference to apparatus shown in FIG. 3, the visibly opaque layer includes three layers. The apparatus 200 and 300 shown in FIGS. 2 and 3 respectively are, for instance, included within an electronic device such as the electronic device 100 shown in FIG. 1.

More particularly, the apparatus 200 shown in FIG. 2 includes a lens 206 decorated with a visibly opaque coating having a transparent layer 208 in combination with a dichroic filter layer 210. The transparent layer 208 is a layer of material configured to be both transparent to light in the visible band as well as light in the infrared band. Light in the visual band, also referred to herein as visible light, means light having a wavelength between approximately 400 nanometers and 700 nanometers and/or that is visible to the human eye. This range of wavelengths corresponds to a band of frequencies, i.e., a frequency range, of about 430-790 terahertz. Light in the infrared band means light having a wavelength that extends from the nominal red edge of the visible spectrum at about 700 nanometers to about 1 millimeter. This range of wavelengths corresponds to a frequency range of approximately 430 Terahertz down to 300 gigahertz.

For example, the transparent layer 208 is at least 50% transmissive to light in the visible band and at least 50% transmissive to light in the infrared band. In another example, the transparent layer 208 is around 80% or more transmissive to infrared light. In a further example, the transparent layer 208 is around 85% or more transmissive to infrared light. In a first embodiment, the transparent layer 208 is a layer of non-black ink. In another embodiment, the transparent layer 208 is configured as a non-black dichroic filter. A dichroic filter, as the term is used herein, means a thin film filter that is configured or designed to pass light of certain frequency bands and to block light in other frequency bands. The non-black ink can have any suitable non-black color ranging from white or nearly white to silver, shades of red, blue, green, etc.

The dichroic filter layer 210 is a layer of material configured to operate or function as a dichroic filter that is at least transparent to infrared light. In one embodiment, the dichroic filter layer 210 is a cold mirror, which is defined as a dichroic filter that reflect the entire or substantially the entire visible light spectrum or range of frequencies while allowing passage of infrared light. In one example, the cold mirror is around 2% or less transmissive of visible light and around 80% or more transmissive of infrared light. In another embodiment, the cold mirror is around 1% or less transmissive of visible light and around 90% or more transmissive of infrared light.

In a further embodiment, the visibly opaque coating created by the combination of the transparent layer 208 and the dichroic filter layer 210 is also designed and/or configured in a way such that it does not interfere with electrical or electronic components disposed in a location beneath or covered by (depending of course on the orientation of the apparatus) at least portion of and thereby, adjacent, the coating. In one example arrangement, the transparent layer 208 and the dichroic filter layer 210 in combination create a uniform visibly opaque coating in a first portion of the first area of the lens to be oriented to cover an infrared element 212 within the apparatus 200, of an assembled electronic device, e.g., 100.

The infrared element 212 is configured to communicate the light in the infrared band. Therefore, the combination of the transparent layer 208 and the dichroic filter layer 210 is configured in a way such that it does not interfere with communication of the infrared light. Communication of the infrared light means emitting infrared light 214, detecting a reflection 216 of the infrared light, or both, by the infrared element 212. How the infrared element 212 communicates the infrared light depends on whether this element includes an emitter, a detector, or both, which can be used for instance as a proximity sensor or a portion of the sensor. Only one infrared element 212 is shown for simplicity. However, any number of infrared elements that have both emitter and detector capabilities or one of these capabilities can be included in an electronic device that practices the present teachings.

In one particular embodiment, the uniform visibly opaque coating, formed by the combination of the transparent layer 208 and the dichroic filter layer 210 in the first portion of the first area of the lens, is around two percent or less transmissive of light having a wavelength between about 400 and 700 nanometers and around 80 percent or more transmissive of light having a wavelength between about 850 nanometers to one millimeter. In another embodiment, the uniform visibly opaque coating, formed by the combination of the transparent layer 208 and the dichroic filter layer 210, is around 85 percent or more transmissive of light having a wavelength between 850 nanometers to one millimeter.

The embodiment of the apparatus 300 shown in FIG. 3 is similar to the apparatus 200 shown in FIG. 2. However, the apparatus 300 further includes an opaque layer 302 applied within the first area of the lens, wherein the opaque layer is opaque to the light in the visible band. An example opaque layer 302 is a non-black ink. In a further example, the light transmissive properties are different for the combination of the transparent layer 208 and the dichroic filter layer 210 of the three layer system 300 than for the combination of the transparent layer 208 and the dichroic filter layer 210 of the two layer system 200. For instance, the combination of the transparent layer 208 and the dichroic filter layer 210 is between five and ten percent transmissive to light having a wavelength between 400 to 700 nanometers and greater than 80 percent transmissive to light having a wavelength between 850 nanometers to one millimeter. With the addition of the opaque layer 302 the combination of the three layers 208, 210 and 302 is about 1% transmissive in the 400 nm to 700 nm wavelengths, and 85% transmissive in 850 nm to one mm wavelengths.

In yet another embodiment, the opaque layer 302 is opaque to the light in the infrared band. Accordingly, the opaque layer 302 has an opening 304 in a first portion of the opaque layer to be oriented adjacent to an infrared element 212, of an assembled electronic device, which communicates the light 214, 216 in the infrared band.

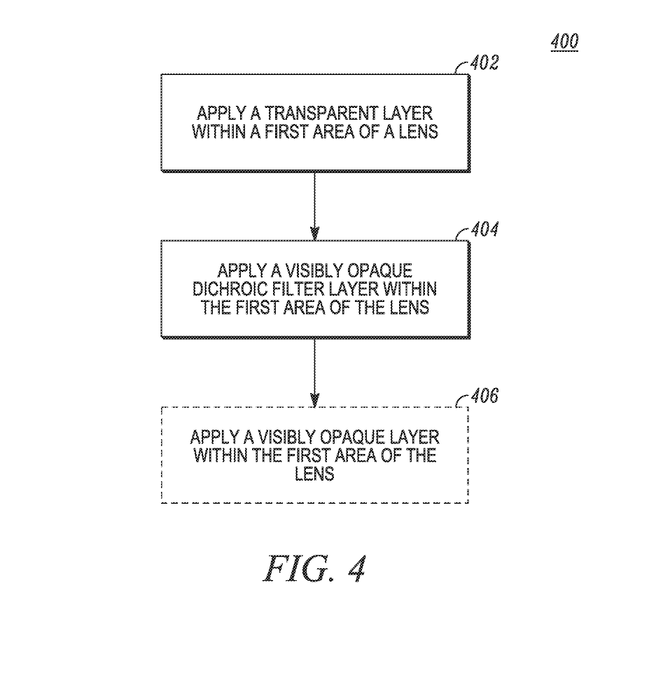

FIG. 4 describes an embodiment of a general method 400 for decorating a lens in accordance with the present teachings. The method 400 represents at least a part of a process for manufacturing an electronic device such as the electronic device 100 of FIG. 1. Accordingly, a part of the device manufacturing process as relates to aspects of some embodiments as method 400 depicts includes applying 402 a transparent layer within a first area of a lens. To apply as used herein refers to painting, printing, depositing or any other method of putting one material on another. The transparent layer is transparent to light in a visible band and transparent to light in an infrared band. The method 400 also includes applying 404 a visibly opaque dichroic filter layer within the first area of the lens. The dichroic filter layer is configured to be transparent to the light in the infrared band. In one embodiment, the method 400 also includes applying 406 a visibly opaque layer within the first area of the lens.

The method 400 is illustratively included within or applied to any suitable electronic device manufacturing process or portion thereof In one particular example, the transparent layer includes a non-black ink that is applied using a printing or painting process. As described herein the printing process includes screen printing, digital printing, heat printing, wick printing, and the like. In another embodiment, the transparent layer is a non-black colored dichroic filter. Illustratively the dichroic filter layer and/or the non-black dichroic filter transparent layer is applied using a deposition process. Example deposition processes as described herein include physical vapor deposition (PVD), chemical vapor deposition (CVD), and hybrid physical-chemical vapor deposition processes. The PVD processes include cathodic arc deposition, electron beam physical vapor deposition, evaporative deposition, pulsed laser deposition, and sputter deposition. The CVD processes include aerosol assisted CVD, direct liquid injection CVD, plasma CVD process, atomic-layer CVD, combustion CVD, hot-wire CVD, metalorganic CVD, rapid thermal CVD, vapor-phase epitaxy, photo-initiated CVD.

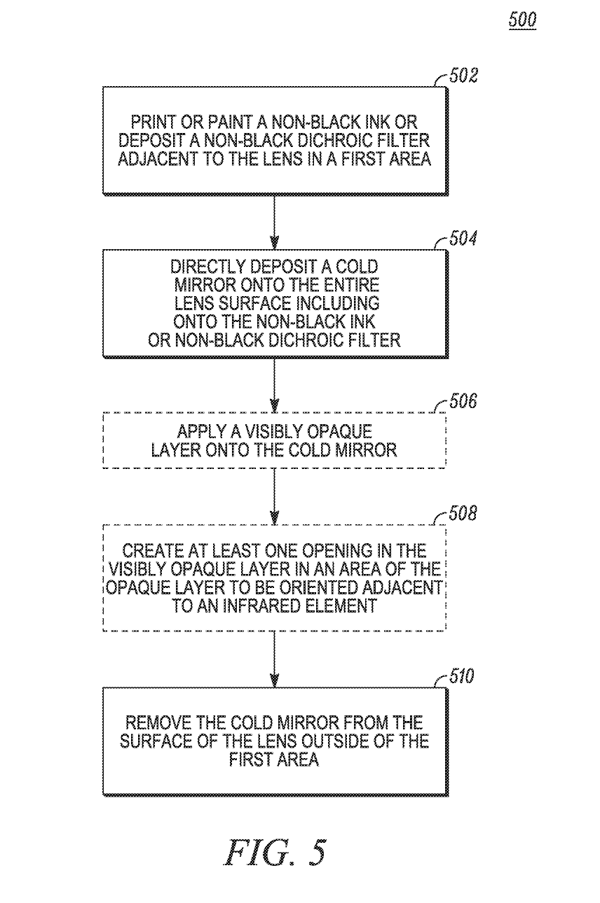

Turning now to further details of applying the transparent layer and the dichroic filter layer as shown in method 500 of FIG. 5. The method 500 describes one way of applying a transparent layer to a first area of a lens including printing or painting 502 a non-black ink, or depositing a non-black dichroic filter layer adjacent to the lens in the first area. Applying a layer adjacent to something as used herein means applying directly on without any intervening layers therebetween. Thus, in this example, the transparent layer is applied to the first area of the lens without any intervening layers between the transparent layer and the first area of the lens. Illustratively, the transparent layer is applied adjacent to the lens in the first area and the dichroic filter layer is directly deposited on the transparent layer. Applying the dichroic filter layer includes directly depositing 504 a cold mirror onto the entire lens surface including onto the non-black ink or non-black dichroic filter. Further, the dichroic filter layer is also directly deposited onto the second area of the lens that is outside the first area of the lens. Directly depositing, as used herein, means depositing one material or layer on another without any intervening materials, such as laminates, adhesives, and so forth.

In one example, the method 500 further includes applying 506 a visibly opaque layer onto the cold mirror. That is, the visibly opaque layer is applied, for example, onto the dichroic filter layer. The visibly opaque layer is opaque to light in the visible band. In one embodiment, at least one opening is created 508 in the visibly opaque layer in an area of the opaque layer to be oriented adjacent to an infrared element. The infrared element is illustratively a component of an assembled electronic device, such as electronic device 100, which is configured to communicate the light in the infrared band. The cold mirror is removed 510 from the surface of the lens outside of the first area using the opaque layer as a mask. In other words, in one example, the dichroic filter layer is removed from the second area using the opaque layer as a mask.

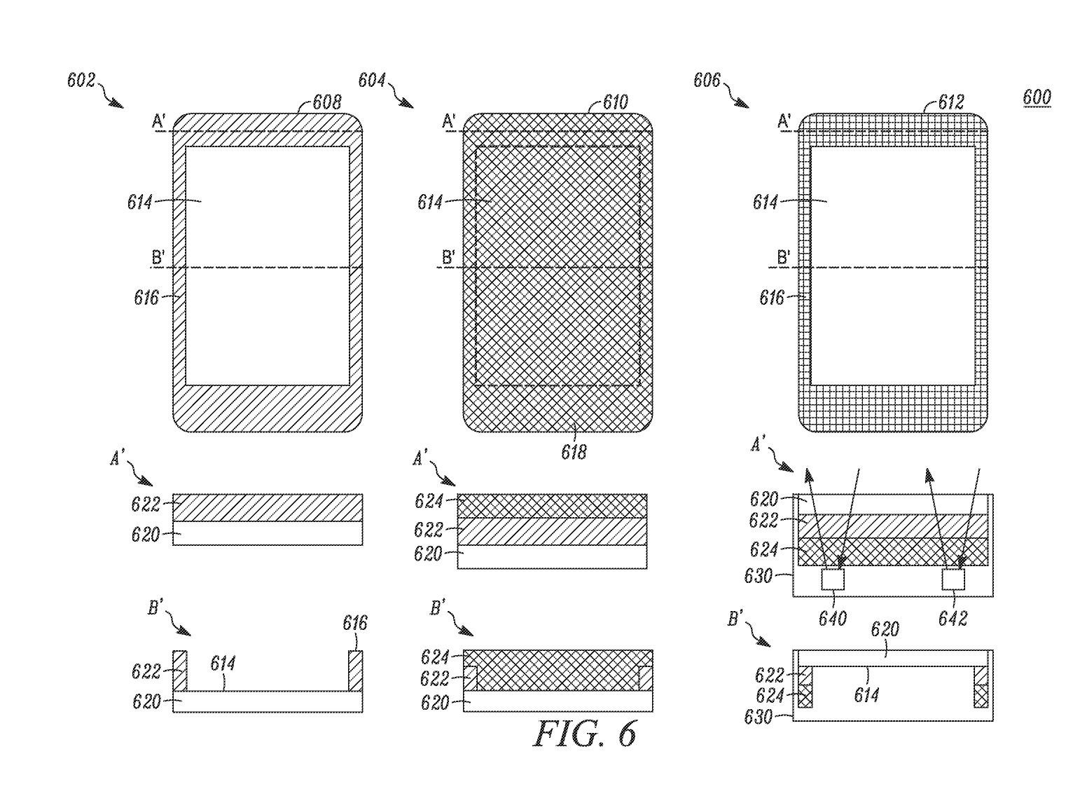

Turning now to FIG. 6 which shows three schematic views 602, 604, 606 of an electronic device, such as electronic device 100, in various states of a manufacturing process for applying a transparent layer and a dichroic filter layer to a lens. Each schematic view of the electronic device contains plan views 608, 610, 612 and associated cross-sectional views A′, B′. The plan views 608, 610 illustrate the electronic device positioned in a face down manner as the transparent layer 622 and the dichroic filter layer 624 are applied to the lens 620. Because the plan views 608, 610 show the electronic device face down, the lens 620 is depicted as below the transparent layer 622 and the dichroic filter layer 624. The plan view 612 illustrates the electronic device positioned in a face-up manner after the layers 622, 624 are applied and a housing 630 is positioned surrounding the lens 620.

The cross-sectional views A′, B′ are at two different locations of the electronic device. The cross-sectional views A′, B′ include an illustration of the layers 622, 624 that, in combination, are applied to the lens 620. The cross-sectional view A′ is at an end of the electronic device where, in some examples, one or more infrared elements 640, 642 are located. The cross-sectional view B′ is at a location that cuts laterally across the electronic device near its center.

The plan view 608 illustrates the first area 616 and the viewing region 614 of the lens 620. At this stage of the manufacturing process a transparent layer 622 is applied within the first area 616 of the lens 620. The transparent layer 622 is applied within the first area 616 of the lens 620 such that the transparent layer 622 covers the first area 616 of the lens 620 and leaves viewing region 614 of the lens 620 exposed. Accordingly, the transparent layer 622 is substantially coextensive with the first area 616 of the lens 622. The cross-sectional view A′ illustrates a cross-section of the electronic device where the transparent layer 622 covers the full width of the lens 620. The cross-sectional view B′ of plan view 608 illustrates a cross-section of the electronic device where the transparent layer 622 is formed at edges of the lens 620 leaving the viewing region 614 exposed.

The plan view 610 illustrates the electronic device after the dichroic filter layer 624 is applied within the first area of the lens 620. Illustratively, the dichroic filter layer 624 is a cold mirror layer. In one example, applying the dichroic filter layer 624 includes applying the dichroic filter layer 624 to an entire surface 618 of the lens 620 such that dichroic filter layer 624 covers the viewing region 614 and first area 616. In other embodiments, a mask (not pictured) is positioned over the viewing region 614 so that when the dichroic filter layer 624 is applied, the dichroic filter layer 624 covers the mask and the first area 616, but not the viewing region 614 of the lens 620. Regardless, the dichroic filter layer 624 is directly applied within the first area 616 of the lens 620. That is, the dichroic filter layer 624 is applied to the first area 616 of the lens 620 without any intervening adhesive or laminates, and the like. In one example the dichroic filter layer 624 is directly deposited on the transparent layer 622.

The plan view 612 illustrates the electronic device after the dichroic filter layer 624 is etched from the viewing region 614 of the lens 620. A mask (not pictured) is placed over the dichroic filter layer in an area substantially coextensive with the first area 616 before etching. The dichroic filter layer 624 is then etched to expose the viewing region 614. The electronic device is now turned right-side up so that the lens 620 is facing upwards with the lens 620 as the upper-most layer above the layers 622, 624. Further, a housing 630 now surrounds the first area 616 of the lens 620.

After the dichroic filter layer 624 is etched from the viewing region 614, the electronic device is in a state such that the transparent layer 622 is applied adjacent to the lens 620 in the first area 616, and the dichroic filter layer 624 is directly applied to the transparent layer 622. With the dichroic filter layer 624 directly applied to the transparent layer 622, the transparent layer 622 and the dichroic filter layer 624 in combination create a uniform visibly opaque coating that is configured to be transparent to the light in the infrared band. The transparent layer 622 and the dichroic filter layer 624 in combination also create the non-white color that is visible through the lens 620.

Illustratively, the first area 616 covers at least one infrared element 640, 642. The elements 640, 642 in one example are an emitter 640 and a detector 642, or in other examples each of the elements 640, 642 contains an emitter and detector where each element 640, 642 is configured to communicate infrared light. Because the transparent layer 622 in combination with the dichroic filter layer 624 is transparent to light in the infrared band, infrared elements 640, 642 disposed beneath the layers 622, 624 operate with minimal interference from the layers 622, 624. Further, because the transparent layer 622 in combination with the dichroic filter layer 624 is visibly opaque, the infrared elements 640, 642 disposed beneath the layers 622, 624 are not visible when looking through the lens 620 and the layers 622, 624.

As cross-sectional view A′ associated with plan view 612 shows, the electronic device illustratively includes the lens 620, transparent layer 622, and dichroic filter layer 624 covering the at least one infrared element 640, 642. In one example, the transparent layer 622 and the dichroic filter layer 624 in combination create a uniform visibly opaque coating over the at least one infrared element 640, 642, which is transparent to the light in the infrared band that is emitted by the at least one infrared element 640, 642.

In one example, because the transparent layer 622 and the dichroic filter layer 624 are transparent to light in the infrared band, there is no need to create an opening in either the transparent layer 622 or the dichroic filter layer 624 for the elements 640, 642 to operate properly. Thus, the transparent layer 622 and dichroic filter layer 624 are seamlessly applied within the first area 616 of the lens 620. That is, no openings or discolorations are in the transparent layer 622 or dichroic filter layer 624.

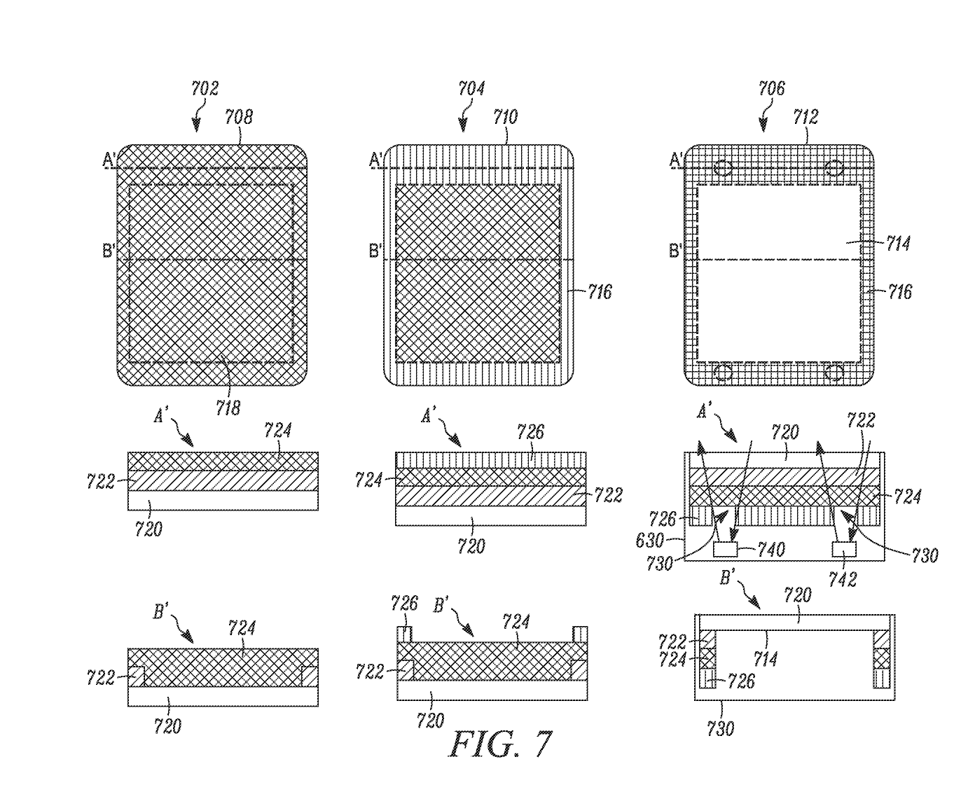

FIG. 7 shows three schematic views 702, 704, 706 of an electronic device, such as electronic device 100 in various states of a manufacturing process for applying a transparent layer, a dichroic filter layer, and an opaque layer. Each schematic view of the electronic device contains plan views 708, 710, 712 and associated cross-sectional views A′, B′ of the device at different stages of the manufacturing process. The plan view 708 illustrates the electronic device positioned in a face down manner with the transparent layer 722, and the dichroic filter layer 724 applied to the lens 720. The plan view 710 illustrates the electronic device positioned in a face down manner having the transparent layer 722, the dichroic filter layer 724, and the opaque layer 726. The plan view 712 illustrates the electronic device positioned in a face-up manner having a housing 730 and infrared elements 740, 742, after the layers 722, 724, 726 are applied to the lens 720.

The plan view 708 illustrates the device after the dichroic filter layer 724 is applied to the entire surface 718 of the lens 720. The transparent layer 722 and the dichroic filter layer 724 are applied in a substantially similar manner as shown in FIG. 6. Thus the transparent layer 722 is applied within the first area 716 of the lens 720 such that the transparent layer 722 covers the first area 716 of the lens 720 and leaves viewing region 714 of the lens 720 exposed. Accordingly, the transparent layer 722 is substantially coextensive with the first area 716 of the lens 720. The cross-sectional view A′ illustrates a cross-section of the electronic device where the transparent layer 722 covers the full width of the lens 720. The cross-sectional view B′ illustrates a cross-section of the electronic device where the transparent layer 722 is formed at edges of the lens 720. As cross-sectional view B′ shows, the dichroic filter layer 724 covers the entire surface of the lens 720 including the viewing region 714.

Further, the plan view 708 illustrates that the dichroic filter layer 724 is applied to an entire surface 718 of the lens 720 such that dichroic filter layer 724 covers the viewing region 714 and first area 716. Illustratively, the dichroic filter layer 724 is directly applied within the first area 716.

Plan view 710 illustrates the device after the opaque layer 726 is applied to the dichroic filter layer 724. The dichroic filter layer 724, in one embodiment, is a cold mirror. Thus, for example, the opaque layer 726 is applied to the cold mirror, wherein the opaque layer 726 is opaque to light in the visible band. In this example, the opaque layer 726 is applied within the first area 716 of the lens 720 . Illustratively, the opaque layer 726 includes non-black ink. At cross-section A′, the opaque layer 726 covers a full width of the lens 720. At cross-section B′, the opaque layer 726 is disposed at edges of the lens 720 leaving the dichroic filter layer 724 exposed in an area that is substantially coextensive with the viewing region 714. When formed in this manner, the opaque layer 726 illustratively serves as a mask when etching the dichroic filter layer 724.

The plan view 712 illustrates the electronic device after the dichroic filter layer 724 is etched from the viewing region 714. The electronic device is now turned right-side up so that the lens 720 is now the upper-most layer above the layers 722, 724, 726. The transparent layer 722 is applied adjacent to the lens 720 in the first area 716. The dichroic filter layer 724 is directly deposited on the transparent layer 722, and the opaque layer 726 is applied on the dichroic filter layer 724. A housing 630 now surrounds the first area 716 of the lens 720. As cross-section B′ illustrates, the opaque layer 726, the dichroic filter layer 724, and the transparent layer 722 are illustratively formed at edges of the lens 720.

Cross-section A′ of plan view 712 illustrates that in this embodiment the first area 716 covers at least one infrared element 740, 742. As previously described, the elements 740, 742 are either infrared emitters or detectors, or some combination of emitters and detectors. The opaque layer 726 is opaque to light in the infrared ban and has an opening 730 in a first portion of the opaque layer to be oriented adjacent to an infrared element 740 or 742 of an assembled electronic device 100 which communicates the light in the infrared band. Opaque layer includes openings 730 through which the at least one infrared element 740, 742 is configured to emit and detect infrared signals wherein the at least one infrared element 740, 742 is covered by the transparent layer 722 and the dichroic filter layer 724. Although the opaque layer 726 includes one or more openings 730, the appearance of the first area 716 still has a substantially seamless appearance because the transparent layer 722 in combination with the dichroic filter layer 724 provides a consistent predominant coloration of the first area 716.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically.

A device or structure that is “configured” in a certain way is configured in at least that way, but may also be configured in ways that are not listed. As used herein, the terms “configured to”, “configured with”, “arranged to”, “arranged with”, “capable of” and any like or similar terms mean that hardware elements of the device or structure are at least physically arranged, connected, and or coupled to enable the device or structure to function as intended.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A decorated lens comprising:
a lens;
a transparent layer applied within a first area of the lens, wherein the transparent layer is transparent to light in a visible band and transparent to light in an infrared band; and
a dichroic filter layer applied within the first area of the lens, wherein the dichroic filter layer is transparent to the light in the infrared band, and wherein the transparent layer and the dichroic filter layer in combination create a visibly opaque coating on the first area of the lens.

2. The decorated lens of claim 1, wherein the dichroic filter layer is directly applied within the first area of the lens.

3. The decorated lens of claim 2, wherein the transparent layer is applied adjacent to the lens in the first area, and the dichroic filter layer is directly deposited on the transparent layer.

4. The decorated lens of claim 3, wherein the dichroic filter layer comprises a cold mirror.

5. The decorated lens of claim 4, wherein the transparent layer comprises a non-black ink.

6. The decorated lens of claim 4, wherein the transparent layer comprises a non-black dichroic filter.

7. The decorated lens of claim 1, wherein the transparent layer and the dichroic filter layer in combination create a uniform visibly opaque coating in a first portion of the first area of the lens to be oriented to cover an infrared element, of an assembled electronic device, which is configured to communicate the light in the infrared band.

8. The decorated lens of claim 7, wherein the uniform visibly opaque coating, in the first portion of the first area of the lens, is less than two percent transmissive of light having a wavelength between 400 to 700 nanometers and greater than 80 percent transmissive of light having a wavelength between 850 nanometers to one millimeter.

9. The decorated lens of claim 1 further comprising an opaque layer applied within the first area of the lens, wherein the opaque layer is opaque to the light in the visible band.

10. The decorated lens of claim 9, wherein the opaque layer comprises a non-black ink.

11. The decorated lens of claim 9, wherein the opaque layer is opaque to the light in the infrared band and has an opening in a first portion of the opaque layer to be oriented adjacent to an infrared element, of an assembled electronic device, which communicates the light in the infrared band.

12. The decorated lens of claim 9, wherein the transparent layer is applied adjacent to the lens in the first area, the dichroic filter layer is directly deposited on the transparent layer, and the opaque layer is applied on the dichroic filter layer.

13. The decorated lens of claim 12, wherein the combination of the transparent layer and the dichroic filter layer is between five and ten percent transmissive to light having a wavelength between 400 to 700 nanometers and greater than 80 percent transmissive to light having a wavelength between 850 nanometers to one millimeter.

14. A method of manufacturing a decorated lens, the method comprising:
applying a transparent layer within a first area of a lens, wherein the transparent layer is transparent to light in a visible band and transparent to light in an infrared band; and
applying a visibly opaque dichroic filter layer within the first area of the lens, wherein the dichroic filter layer is transparent to the light in the infrared band.

15. The method of claim 14, wherein the transparent layer is applied adjacent to the lens in the first area, and the dichroic filter layer is directly deposited on the transparent layer, the method further comprising applying an opaque layer onto the dichroic filter layer, wherein the opaque layer is opaque to the light in the visible band.

16. The method of claim 15, wherein the dichroic filter layer is also directly deposited onto a second area of the lens that is outside of the first area of the lens, the method further comprising removing the dichroic filter layer from the second area using the opaque layer as a mask.

17. The method of claim 15 further comprising creating an opening in an area of the opaque layer to be oriented adjacent to an infrared element, of an assembled electronic device, which is configured to communicate the light in the infrared band.

18. An electronic device comprising:
an infrared element configured to communicate light in the infrared band;
a lens having a first area comprising at least a portion of a border of the lens that covers the infrared element;
a transparent layer applied adjacent to the lens in the first area, wherein the transparent layer is transparent to light in a visible band and transparent to light in an infrared band; and
a cold mirror directly applied to the transparent layer, wherein the transparent layer and the cold mirror in combination create a uniform visibly opaque coating on at least the portion of the border of the lens that covers the infrared element.

19. The electronic device of claim 18 further comprising an opaque layer applied to the cold mirror, wherein the opaque layer is opaque to the light in the visible band.

20. The electronic device of claim 19, wherein the opaque layer is opaque to the light in the infrared band and has an opening adjacent to the infrared element.
